(19) United States
(12) Patent Application Publication
(10) Pub. No.: US 2024/0359349 A1
(43) Pub. Date: Oct. 31, 2024

(54) RAZOR HANDLE

(71) Applicant: DORCO CO., LTD., Seoul (KR)

(72) Inventors: Ji Hun KI, Seoul (KR); Se Min PARK, Seoul (KR)

(21) Appl. No.: 18/647,533

(22) Filed: Apr. 26, 2024

(30) Foreign Application Priority Data
Apr. 28, 2023 (KR) 10-2023-0056113

(51) Int. Cl. B26B 21/52; B26B 21/22

(52) U.S. Cl. CPC B26B 21/521; B26B 21/222; B26B 21/523

(57) ABSTRACT

Proposed is a razor handle. The razor handle may include a handle body including a first opening and a second opening formed at both ends thereof, and a head portion including a cartridge coupling portion at least partially exposed to the outside of the first opening, and a head body extending from the cartridge coupling portion and accommodated in the handle body through the first opening. The razor handle may also include a tail portion including a distal end portion at least partially exposed to the outside of the second opening, and a tail body extending from the distal end portion and accommodated in the handle body through the second opening. The head body may be detachably coupled to at least one of the handle body or the tail body, and the tail body may be detachably coupled to at least one of the handle body or the head body.

### CROSS REFERENCE TO RELATED APPLICATION

This application is based on and claims priority under 35 U.S.C. § 119 to Korean Patent Application No. 10-2023-0056113 filed on Apr. 28, 2023 in the Korean Intellectual Property Office, the disclosure of which is incorporated by reference herein in its entirety.

### BACKGROUND

### Technical Field

The disclosure relates to a razor handle, and more particularly to a razor handle coupled to a razor cartridge.

### Description of Related Technology

In general, a razor refers to a product for cutting body hair such as fuzz and stubble on a face or body, and includes a razor handle for a grip, and a razor cartridge with a razor blade that comes into contact with skin to have a shave.

### SUMMARY

One aspect is a razor handle having a structure of which an assembly process is more simplified.

Aspects of the disclosure are not limited to those disclosed herein, and other aspects not mentioned may become apparent to those skilled in the art from the following description.

Another aspect is a razor handle including: a handle body that includes a first opening formed at a first end thereof in a lengthwise direction, and a second opening formed at a second end thereof in the lengthwise direction; a head portion that includes a cartridge coupling portion at least partially exposed to the outside of the first opening and coupling with the razor cartridge, and a head body extending from the cartridge coupling portion and accommodated in the handle body through the first opening; and a tail portion that includes a distal end portion at least partially exposed to the outside of the second opening, and a tail body extending from the distal end portion and accommodated in the handle body through the second opening, wherein the head body is detachably coupled to at least one of the handle body and the tail body, and the tail body is detachably coupled to at least one of the handle body and the head body

Other details of the disclosure are included in the detailed description and the accompanying drawings.

### BRIEF DESCRIPTION OF THE DRAWINGS

FIG. 1 is a bottom view illustrating a razor assembly according to an embodiment of the disclosure.

FIG. 2 is a perspective view illustrating an upper side of a razor handle according to an embodiment of the disclosure.

FIG. 3 is a perspective view illustrating a lower side of a razor handle according to an embodiment of the disclosure.

FIG. 4 is an exploded perspective view of a razor handle according to an embodiment of the disclosure.

FIG. 5 is a perspective view illustrating an assembled state between a head portion and a tail portion in a razor handle according to an embodiment of the disclosure.

FIG. 6 is a disassembled view illustrating a head portion and a tail portion in a razor handle according to another embodiment of the disclosure.

FIG. 7 is an exploded perspective view illustrating a razor handle according to still another embodiment of the disclosure.

FIG. 8 is a perspective view illustrating a tail portion of the razor handle according to the embodiment shown in FIG. 7.

FIG. 9 is a perspective view illustrating an assembled state between a head portion and the tail portion in the razor handle according to the embodiment shown in FIG. 7.

FIG. 10 is a perspective view illustrating a partially cut-open handle body in the razor handle according to the embodiment shown in FIG. 7.

FIG. 11 is an enlarged view of “A” in FIG. 10.

FIG. 12 is a view schematically illustrating an assembled state between a head portion and a tail portion in a razor handle according to still another embodiment of the disclosure.

FIG. 13 is a view schematically illustrating an assembled state between a head portion and a tail portion in a razor handle according to still another embodiment of the disclosure.

### DETAILED DESCRIPTION

To make the razor cartridge come into close contact with a user's skin along the curvy contours of the skin, the razor cartridge is rotatably coupled to the razor handle.

The razor handle includes a grip portion to be held by a user, and a cartridge coupling portion coupled to the razor cartridge. Meanwhile, a conventional general system razor handle has been manufactured by bonding the cartridge coupling portion to the grip portion. Such a manufacturing method has problems of slow work speed, and poor appearance quality due to the exposure of glue.

The merits and characteristics of the disclosure and a method for achieving the merits and characteristics will become more apparent from embodiments described below in detail in conjunction with the accompanying drawings. However, the disclosure is not limited to the disclosed embodiments, but may be implemented in various different ways. The embodiments are provided to only complete the disclosure and to allow those skilled in the art to understand the category of the disclosure. The disclosure is defined by the category of the claims.

In addition, embodiments of the disclosure will be described with reference to cross-sectional views and/or schematic views as idealized exemplary illustrations. Therefore, the illustrations may be varied in shape depending on manufacturing techniques, tolerance, and/or etc. Further, elements in the drawings may be relatively enlarged or reduced for convenience of description. Like numerals refer to like elements throughout.

Further, first, second, i), ii), a), b) and the like terms may be used in describing elements according to embodiments of the disclosure. Such terms are used solely for the purpose of differentiating one element from another, but not limit the substances, the order, sequence, etc. of those elements. Throughout this specification, when a part ‘includes’ or ‘comprises’ an element, the part is meant to further include other elements rather than excluding other elements unless otherwise stated explicitly.

Below, a razor handle and a razor assembly including the same according to embodiment of the disclosure will be described with reference to the accompanying drawings

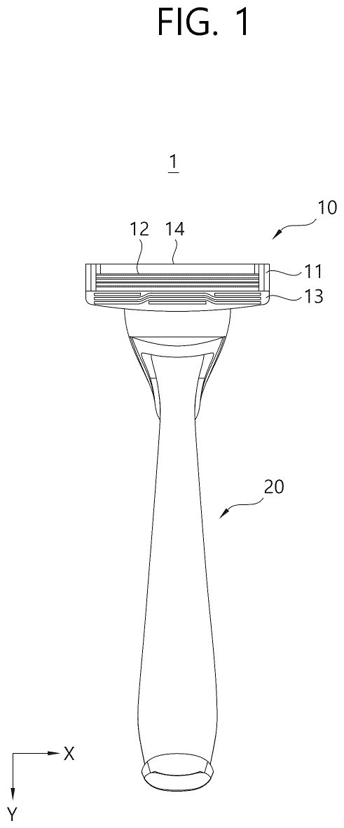

FIG. 1 is a bottom view illustrating a razor assembly 1 according to an embodiment of the disclosure.

Referring to FIG. 1, the razor assembly 1 according to an embodiment includes a razor cartridge 10, and a razor handle 20 to which the razor cartridge 10 is rotatably coupled.

The razor cartridge 10 is detachably coupled to the razor handle 20. Further, the razor cartridge 10 may be rotatably supported within a specific angle range with respect to the razor handle 20.

Referring to FIG. 1, the razor cartridge 10 may include all or some of a blade housing 11, at least one blade 12, a guard 13, and a cap 14.

The blade housing 11 accommodates the blades 12 in the longitudinal direction of the razor cartridge 10, and the blades 12 may be arranged in a row in the transverse direction of the razor cartridge 10. In FIG. 1, the longitudinal direction of the razor cartridge 10 refers to an X-axial direction, and the transverse direction of the razor cartridge 10 refers to a Y-axial direction.

Although not shown, the razor cartridge 10 may further include a skin contact member (not shown) disposed between two blades 12 to come into contact with skin during a shaving process. The skin contact member may pull the skin and thus enable the following blade 12 to cut body hair smoothly during the shaving process. Besides, the skin contact member may align the body hair and thus enable the following blade 12 to cut the body hair smoothly during the shaving process, and, in this case, the skin contact member may have a comb structure. Alternatively, the skin contact member may come into contact with skin and apply a lubricating substance to the skin during the shaving process.

The guard 13 may be provided on one side of the blade housing 11. In more detail, the guard 13 may be positioned in front of the blades 12. The front of the blades 12 refers to a direction in which a cutting edge of each blade 12 faces.

The guard 13 pulls a user's skin while being in contact with the skin during the shaving process, thereby improving a shaving effect of the blade 12. To make the guard 13 pull a user's skin more effectively, the guard 13 may be formed with an embossed or engraved pattern on the top surface thereof, and the top surface of the guard 13 may be made of rubber, silicone, and the like material.

The cap 14 may be provided on the other side of the blade housing 11. In more detail, the cap 14 may be positioned in back of the blades 12. The back of the blades 12 refers to a direction opposite to the direction in which the cutting edge of each blade 12 faces.

The cap 14 may include a lubrication band exposed to the top surface of the blade housing 11. The lubrication band includes the lubricating substance, so that the lubricating substance can be applied to the surface of skin where the blade 12 has passed during the shaving process. The lubricating substance may contain ingredients for protecting the skin before and after shaving.

Below, the razor handle 20 will be described in detail.

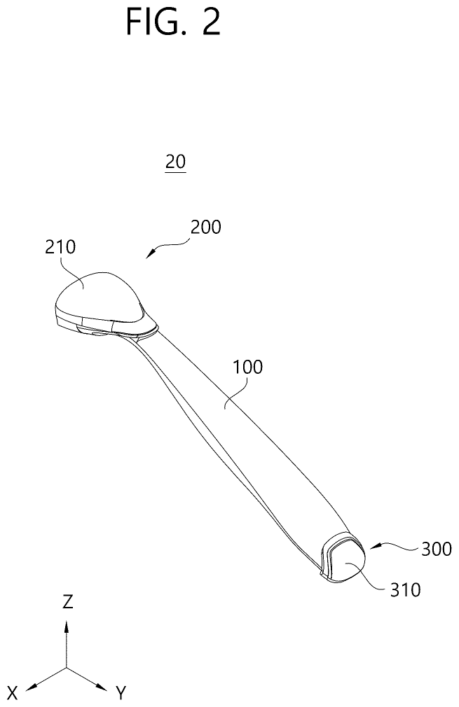

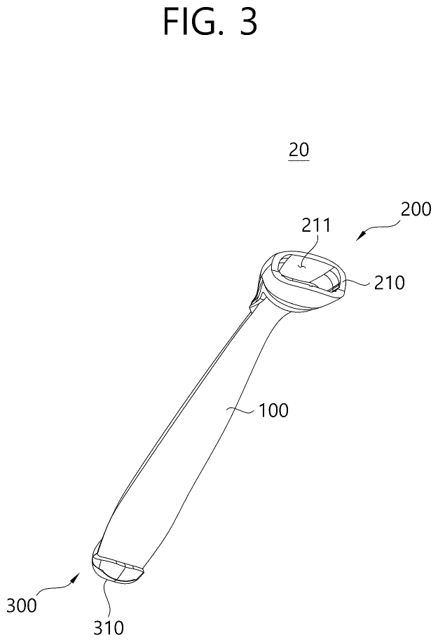

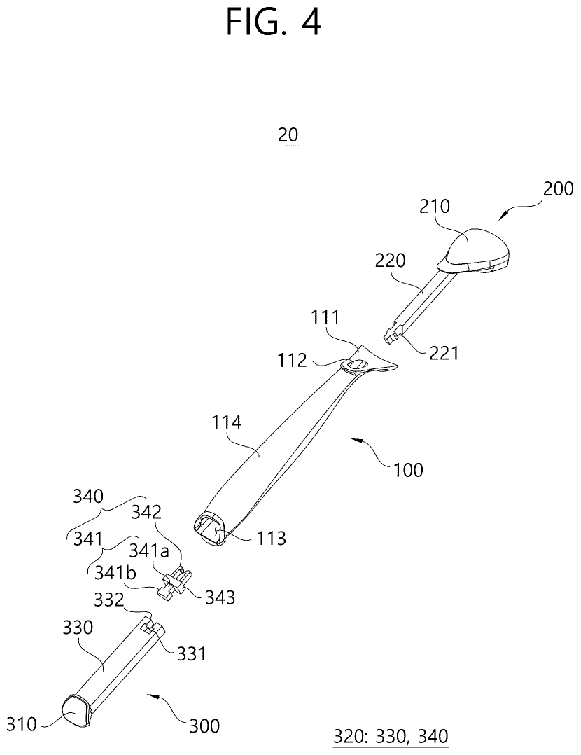

FIG. 2 is a perspective view illustrating an upper side of the razor handle 20 according to an embodiment of the disclosure, FIG. 3 is a perspective view illustrating a lower side of the razor handle 20 according to an embodiment of the disclosure, and FIG. 4 is an exploded perspective view of the razor handle 20 according to an embodiment of the disclosure.

Referring to FIGS. 2 to 4, the razor handle 20 according to an embodiment of the disclosure includes a handle body 100, a head portion 200, and a tail portion 300.

Referring to FIG. 2, the head portion 200 is coupled to the handle body 100 with a cartridge coupling portion 210 exposed to the outside, and the tail portion 300 is coupled to the handle body 100 with a distal end portion 310 exposed to the outside. The cartridge coupling portion 210 and the distal end portion 310 may be positioned at the opposite ends of the handle body 100 in the lengthwise direction (i.e., Y-axis direction) of the razor handle 20, respectively.

Referring to FIG. 3, the cartridge coupling portion 210 may be formed with a cartridge accommodating groove 211, in which the razor cartridge 10 is detachably accommodated, at a first end thereof. FIG. 3 illustrates the cartridge accommodating groove 211 as an example of a structure to which the razor cartridge 10 is detachably coupled, but the cartridge coupling portion 210 may have various structures for detachably coupling the razor cartridge 10 thereto according to embodiments.

Referring to FIG. 4, the handle body 100 includes a first opening 112 formed at the first end thereof in the lengthwise direction, and a second opening 113 formed at the second end thereof in the lengthwise direction. The handle body 100 may be formed with a space through which the first opening 112 and the second opening 113 are connected. Further, the handle body 100 may include a seating surface 111 on which the cartridge coupling portion 210 is seated, and the seating surface 111 may be formed around the first opening 112.

The handle body 100 may be formed with a grip portion 114 on the outer surface thereof to increase friction between a user's hand and the handle body 100. The grip portion 114 may include a high-friction material (for example, silicone, rubber, etc.) and/or may have a high-friction structure (for example, an uneven pattern).

Referring back to FIG. 4, the head portion 200 may include the cartridge coupling portion 210, and a head body 220.

The cartridge coupling portion 210 refers to an element that is detachably coupled to the razor cartridge 10, and may be positioned to be exposed to the outside of the handle body 100. The head body 220 extends from the cartridge coupling portion 210 toward the rear end of the razor handle 20 in the lengthwise direction, and is accommodated in the handle body 100 through the first opening 112.

The cartridge coupling portion 210 and/or the head body 220 may be made of metal to ensure the rigidity and weightiness of the razor handle 20. Alternatively, the cartridge coupling portion 210 and/or the head body 220 may be made of plastic for convenience of manufacturing.

The head body 220 may include a locking protrusion 221 formed at the rear end thereof, which will be accommodated in the handle body 100. The locking protrusion 221 may have a structure to be detachably coupled to an elastic coupling portion 342 of a connection member 340, which will be described later. In more detail, the locking protrusion 221 and the clastic coupling portion 342 are coupled by a force acting to move both of them closer to each other in the lengthwise direction of the razor handle 20, and separated by a force acting to move both of them away from each other in the lengthwise direction of the razor handle 20.

The locking protrusion 221 may be formed at an end portion on an inclined surface extending outwardly toward the cartridge coupling portion 210. The elastic coupling portion 342 moves along the inclined surface and is then coupled to the locking protrusion 221 so as not to be easily separated from the head portion 200. However, the elastic coupling portion 342 and the locking protrusion 221 may be configured so that the elastic coupling portion 342 can be separated from the locking protrusion 221 by a force greater than a certain magnitude, which acts to move the connection member 340 and the head portion 200 away from each other. For example, at least one of the elastic coupling portion 342 and the locking protrusion 221 may be formed to be elastically transformed by a force greater than a certain magnitude, or the locking protrusion 221 may include an inclined surface extending outwardly in a direction of separating the elastic coupling portion 342.

The locking protrusion 221 and the elastic coupling portion 342 are just given as an example of structures where the head portion 200 and the connection member 340 are detachably coupled, and the disclosure is not limited to this example.

Referring back to FIG. 4, the tail portion 300 may include a distal end portion 310, and a tail body 320. The tail body 320 may include a tail rod 330, and a connection member 340.

As described above, the distal end portion 310 may be positioned to be exposed to the outside of the handle body 100. The tail rod 330 extends from the distal end portion 310 toward the front end along the lengthwise direction of the razor handle 20, and is accommodated in the handle body 100 through the second opening 113. The connection member 340 may be provided at the front end of the tail rod 330 to be accommodated in the handle body 100.

The tail rod 330 may be made of metal to ensure the rigidity and the weightiness of the razor handle 20. The tail portion 300 may be manufactured to weigh more than the head portion 200 so that a user can feel more stable while using the razor assembly 1. To this end, the tail rod 330 may be formed to have a larger area of a cross-section perpendicular to the lengthwise direction than the head body 220, or to be longer than the head body 220.

The distal end portion 310 may be made of metal integrally with or separately from the tail rod 330, but may alternatively be made of plastic for convenience of manufacturing.

The connection member 340 may be made of plastic because the connection member 340 includes the elastic coupling portion 342 required to be elastically transformed to detachably couple with the locking protrusion 221. However, the connection member 340 according to an embodiment may also be made of metal.

At the front end of the tail rod 330, a protruding end accommodating portion 331 may be formed to accommodate the protruding end 341b of the connection member 340 therein, and a separation preventing portion 332 may be formed to surround at least a portion of the protruding end 341b accommodated in the protruding end accommodating portion 331 and prevent the protruding end 341b from being separated in the lengthwise direction. The separation preventing portion 332 may be formed to protrude toward the inside of the protruding end accommodating portion 331, but is not necessarily limited thereto. The separation preventing portion 332 may have various shapes corresponding to the shapes of the protruding end 341b.

The protruding end accommodating portion 331 is recessed from one surface of the tail rod 330 in a direction different from the lengthwise direction of the razor handle 20, so that the protruding end 341b of the connection member 340 can be inserted in or separated from the protruding end accommodating portion 331 in the direction different from the lengthwise direction. For example, the protruding end accommodating portion 331 is recessed from one surface of the tail rod 330 in a direction perpendicular to the lengthwise direction, so that the protruding end 341b of the connection member 340 can be inserted in or separated from the protruding end accommodating portion 331 in the direction perpendicular to the lengthwise direction.

The connection member 340 may include a tail coupling portion 341, and the elastic coupling portion 342.

The tail coupling portion 341 may include an extension rod 341a extending toward the rear end in the lengthwise direction of the razor handle 20, and the protruding end 341b extending from the extension rod 341a in a direction different from the lengthwise direction.

As described above, the protruding end 341b may be inserted in the protruding end accommodating portion 331 of the tail rod 330, thereby coupling the connection member 340 to the tail rod 330.

For more firmly coupling between the connection member 340 and the tail rod 330, the connection member 340 may further include a supporting end 343. The supporting end 343 is in close contact with the front end of the tail rod 330 and/or the separation preventing portion 332 in the state that the protruding end 341b is placed inside the protruding end accommodating portion 331, so that the connection member 340 can be firmly coupled to the tail rod 330. The extension rod 341a may be formed extending from the supporting end 343 toward the rear end.

The elastic coupling portion 342 may be provided at the front end of the connection member 340. The elastic coupling portion 342 may extend from the supporting end 343 toward the front end. The elastic coupling portion 342 may include at least one hook-shaped member to be detachably hooked to the locking protrusion 221. As an example of a structure where the head body 220 and the tail rod 330 are detachably coupled, FIG. 4 illustrates a detachable hook coupling structure between the elastic coupling portion 342 and the locking protrusion 221. Besides the hook coupling, latch coupling, or snap-fit coupling may be employed for a detachable structure between the elastic coupling portion and the head body. For convenience of description, the elastic coupling portion 342 structured for the hook coupling will be described by way of example, but the disclosure is not limited to this example. Further, FIG. 4 shows an example of including a pair of elastic coupling portions 342 facing each other, but the number and shape of the elastic coupling portions 342 may be varied depending on embodiments.

This embodiment has been described based on a structure where the connection member 340 and the tail rod 330 are separable from each other, but the connection member 340 and the tail rod 330 may alternatively be formed as a single body. In this case, the clastic coupling portion 342 may be formed at the front end of the tail rod 330.

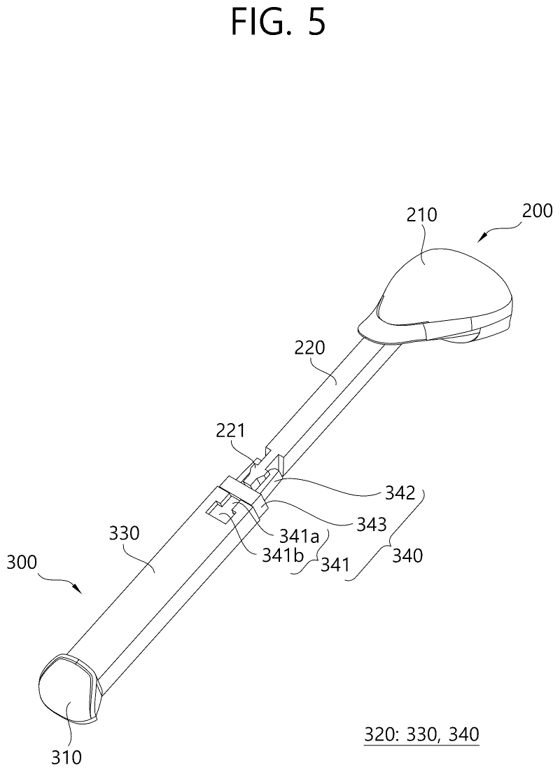

FIG. 5 is a perspective view illustrating an assembled state between the head portion 200 and the tail portion 300 in the razor handle 20 according to an embodiment of the disclosure.

To couple the tail portion 300 with the handle body 100, the connection member 340 coupled to the tail rod 330 is inserted in the handle body 100 through the second opening 113 of the handle body 100.

Further, to couple the head portion 200 with the handle body 100, the head body 220 is inserted in the handle body 100 through the first opening 112.

Referring to FIG. 5, the elastic coupling portion 342 of the connection member 340 is hooked to the locking protrusion 221 inside the handle body 100 by a force acting to move both of them closer to each other in the lengthwise direction of the razor handle 20.

To prevent a clearance between the handle body 100 and the cartridge coupling portion 210 and/or between the handle body 100 and the distal end portion 310 in the state that the head portion 200 and the tail portion 300 are coupled to each other, a distance between the first opening 112 and the second opening 113 may be longer than a distance between the cartridge coupling portion 210 and the distal end portion 310. In this case, the cartridge coupling portion 210 and the distal end portion 310 may be further pressed against each other in the lengthwise direction of the razor handle 20 while the cartridge coupling portion 210 and the distal end portion 310 are seated in the handle body 100 by inserting the head body 220 and the tail body 320 in the handle body 100, thereby achieving complete hook coupling between the clastic coupling portion 342 and the locking protrusion 221.

To separate the head portion 200 and/or the tail portion 300 from the handle body 100, a user applies a force acting to move the cartridge coupling portion 210 and/or the distal end portion 310 exposed to the outside of the handle body 100 away from the handle body 100 in the lengthwise direction of the razor handle 20, and thus the elastic coupling portion 342 and the locking protrusion 221 are released from the hook coupling and separated from each other so that the user can separate the head portion 200 and/or the tail portion 300 from the handle body 100.

Meanwhile, the direction in which the protruding end 341b of the connection member 340 is coupled to/separated from the protruding end accommodating portion 331 is different from the lengthwise direction of the razor handle 20 (for example, a direction perpendicular to the lengthwise direction), and therefore a force acting in the direction different from the lengthwise direction is required to separate the protruding end 341b of the connection member 340 from the protruding end accommodating portion 331. In other words, the coupling between the connection member 340 and the tail rod 330 is not released by the force that acts in the lengthwise direction of the razor handle 20 to separate the elastic coupling portion 342 and the locking protrusion 221.

Therefore, when the coupling between the elastic coupling portion 342 and the locking protrusion 221 is released and then the tail portion 300 is separated from the handle body 100, the tail portion 300 with the connection member 340 coupled to the tail rod 330 is separated from the handle body 100. A user may separate the connection member 340 from the tail portion 300 as necessary.

A conventional razor handle has been manufactured by bonding the cartridge coupling portion and the distal end portion to the handle body. Such a manufacturing method has problems of slow work speed, and poor appearance quality due to the exposure of glue.

On the other hand, the razor handle 20 according to an embodiment of the disclosure is manufactured in such a way that the head portion 200 and the tail portion 300 are inserted through the opposite ends of the handle body 100 and coupled to each other inside the handle body 100 so that the cartridge coupling portion 210 and the distal end portion 310 are fixed to the handle body 100. Therefore, the bonding for fixing the cartridge coupling portion 210 and the distal end portion 310 to the handle body 100 is not required, thereby reducing a defect rate, simplifying an assembly process, and enhancing a production speed.

Further, the razor handle 20 is separable into the handle body 100, the head portion 200 and the tail portion 300, which can be separately recycled according to their materials when the razor handle 20 is discarded.

For example, when the handle body 100 is made of plastic and the head portion 200 and the tail portion 300 are made of metal, the head portion 200 and the tail portion 300 may be recycled separately from the handle body 100.

Further, for example, when the connection member 340 is made of plastic and the distal end portion 310 and the tail rod 330 are made of metal, the tail portion 300 may be separated from the handle body 100 and then the connection member 340 may be separated from the tail portion 300 for recycling.

Below, a razor handle according to another embodiment will be described. For convenience of description, the same numerals will be used for elements similar to those of the foregoing embodiment, and descriptions common to those of the foregoing embodiment will be omitted.

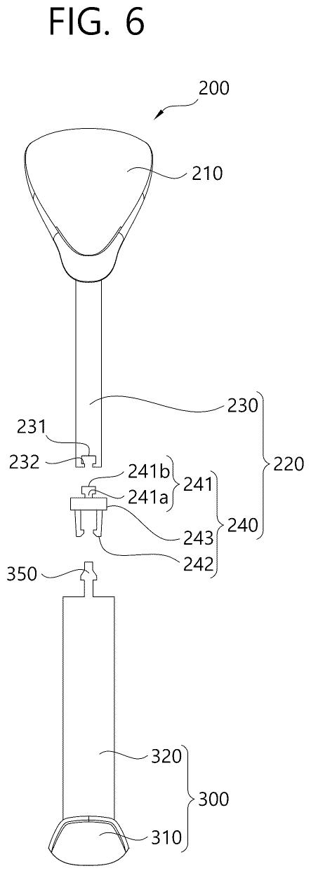

FIG. 6 is a disassembled view illustrating a head portion 200 and a tail portion 300 in a razor handle 20 according to another embodiment of the disclosure.

Referring to FIG. 6, the razor handle 20 according to this embodiment is different from that of the foregoing embodiment in that a connection member 240 is included in the head portion 200 and a locking protrusion 350 is included in the tail portion 300.

According to this embodiment, the head portion 200 of the razor handle 20 also include the cartridge coupling portion 210 and the head body 220.

However, the head body 220 may include a head rod 230 and the connection member 240.

The head rod 230 extends from the cartridge coupling portion 210 toward the rear end in the lengthwise direction of the razor handle 20, and is accommodated in the handle body 100 through the first opening 112. The connection member 240 may be provided at the rear end of the head rod 230 to be accommodated in the handle body 100.

At the rear end of the head rod 230, a protruding end accommodating portion 231 may be formed to accommodate a protruding end 241b of the connection member 240 therein, and a separation preventing portion 232 may be formed to surround at least a portion of the protruding end 241b accommodated in the protruding end accommodating portion 331 and prevent the protruding end 241b from being separated in the lengthwise direction. The separation preventing portion 232 may be formed to protrude toward the inside of the protruding end accommodating portion 231.

The protruding end accommodating portion 231 is recessed from one surface of the head rod 230 in a direction different from the lengthwise direction of the razor handle 20, so that the protruding end 241b of the connection member 240 can be inserted in or separated from the protruding end accommodating portion 231 in the direction different from the lengthwise direction. For example, the protruding end accommodating portion 231 is recessed from one surface of the head rod 230 in a direction perpendicular to the lengthwise direction, so that the protruding end 241b of the connection member 240 can be inserted in or separated from the protruding end accommodating portion 231 in the direction perpendicular to the lengthwise direction.

The connection member 240 may include a head coupling portion 241, and an elastic coupling portion 242.

The head coupling portion 241 may include an extension rod 241a extending toward the front end in the lengthwise direction of the razor handle 20, and the protruding end 241b extending from the extension rod 241a in a direction different from the lengthwise direction.

As described above, the protruding end 241b may be inserted in the protruding end accommodating portion 231 of the head rod 230, thereby coupling the connection member 240 with the head rod 230.

For more firmly coupling between the connection member 240 and the head rod 230, the connection member 240 may further include a supporting end 243. The supporting end 243 is in close contact with the rear end of the head rod 230 and/or the separation preventing portion 232 in the state that the protruding end 241b is placed inside the protruding end accommodating portion 231, so that the connection member 240 can be firmly coupled to the head rod 230. The extension rod 241a may be formed extending from the supporting end 243 toward the front end.

The elastic coupling portion 242 may be provided at the rear end of the connection member 240. The elastic coupling portion 242 may extend from the supporting end 243 toward the rear end. The elastic coupling portion 242 may include at least one hook-shaped member to be detachably hooked to the locking protrusion 350. Further, FIG. 6 shows an example of including a pair of elastic coupling portions 242 facing each other, but the number and shape of the elastic coupling portions 242 may be varied depending on embodiments.

This embodiment has been described based on a structure where the connection member 240 and the head rod 230 are separable from each other, but the connection member 240 and the head rod 230 may alternatively be formed as a single body. In this case, the elastic coupling portion 242 may be formed at the rear end of the head rod 230.

The tail portion 300 may include the distal end portion 310 and the tail body 320.

The tail body 320 extends from the distal end portion 310 toward the front end in the lengthwise direction of the razor handle 20, and is accommodated in the handle body 100 through the second opening 113. The tail portion 300 may be accommodated in the handle body 100 with the distal end portion 310 exposed to the outside of the razor handle 20.

The tail body 320 may include a locking protrusion 350 formed at the front end thereof, which will be accommodated in the handle body 100. The locking protrusion 350 may have a structure to be detachably coupled to the elastic coupling portion 242 of the connection member 240. In more detail, the locking protrusion 350 and the elastic coupling portion 242 are coupled by a force acting to move both of them closer to each other in the lengthwise direction of the razor handle 20, and separated by a force acting to move both of them away from each other in the lengthwise direction of the razor handle 20.

The coupling between the locking protrusion 350 and the elastic coupling portion 242 is similar to the coupling between the locking protrusion 221 and the elastic coupling portion 342 of the foregoing embodiment, and thus repetitive descriptions thereof will be avoided.

The razor handle 20 according to this embodiment is also manufactured in such a way that the head portion 200 and the tail portion 300 are inserted through the opposite ends of the handle body 100 and coupled to each other inside the handle body 100 so that the cartridge coupling portion 210 and the distal end portion 310 are fixed to the handle body 100. Therefore, the bonding for fixing the cartridge coupling portion 210 and the distal end portion 310 to the handle body 100 is not required, thereby reducing a defect rate, simplifying an assembly process, and enhancing a production speed.

Further, the razor handle 20 is separable into the handle body 100, the head portion 200 and the tail portion 300, which can be separately recycled according to their materials when the razor handle 20 is discarded.

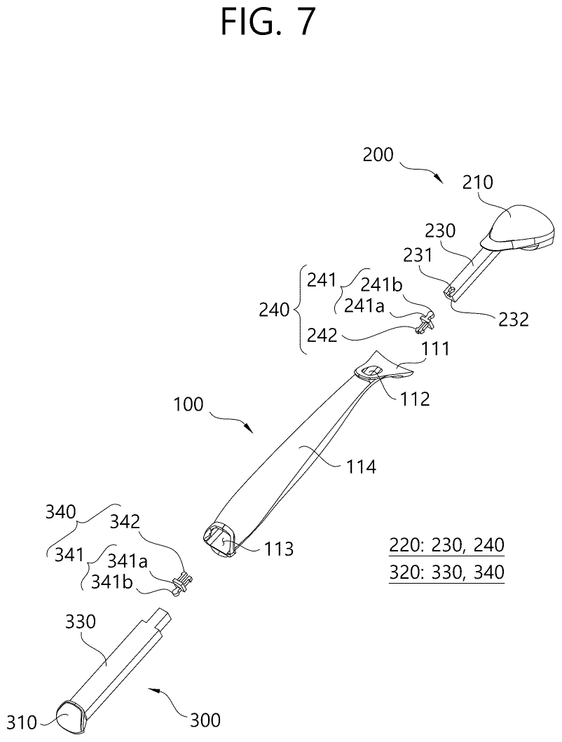

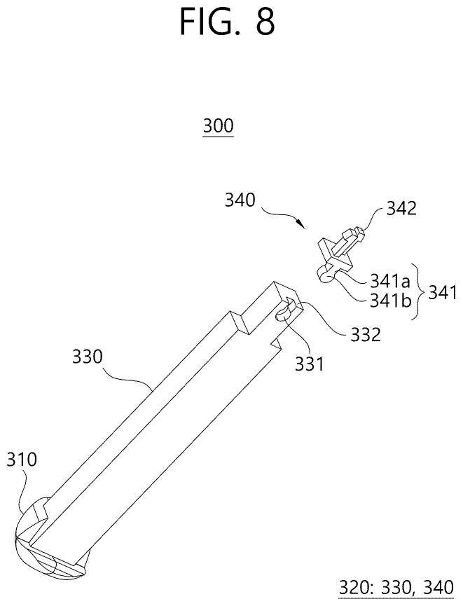

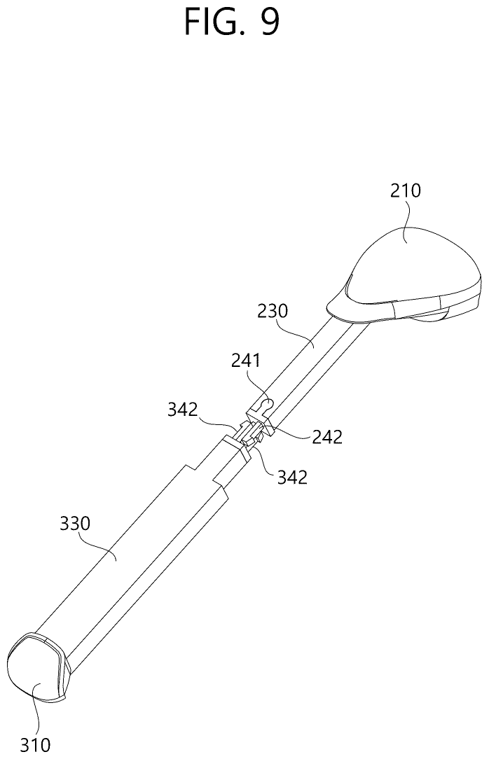

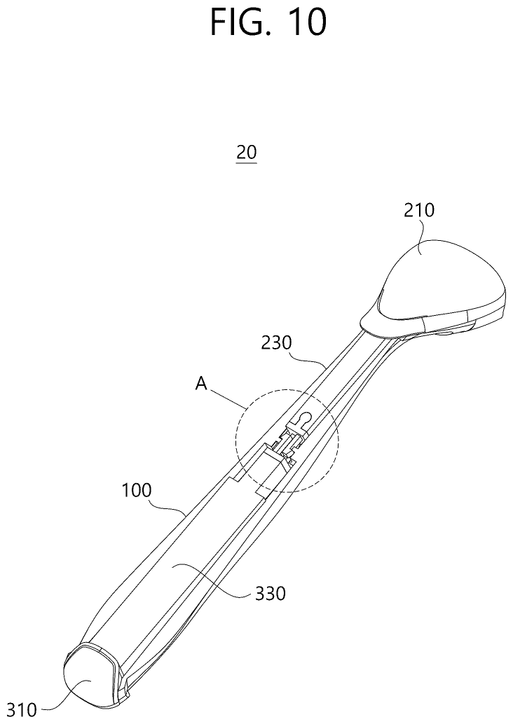

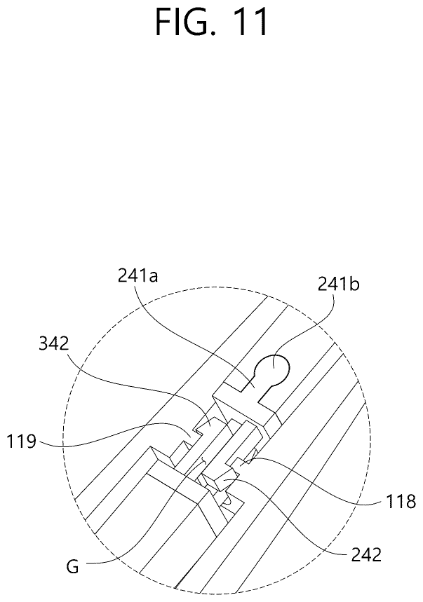

FIG. 7 is an exploded perspective view illustrating a razor handle 20 according to still another embodiment of the disclosure, FIG. 8 is a perspective view illustrating a tail portion 300 of the razor handle 20 according to the embodiment shown in FIG. 7, FIG. 9 is a perspective view illustrating an assembled state between a head portion 200 and the tail portion 300 in the razor handle 20 according to the embodiment shown in FIG. 7, and FIG. 10 is a perspective view illustrating a partially cut-open handle body 100 in the razor handle 20 according to the embodiment shown in FIG. 7, and FIG. 11 is an enlarged view of “A” in FIG. 10.

Referring to FIG. 7, the razor handle 20 according to this embodiment includes a connection member 240 for the head portion 200 and a connection member 340 for the tail portion 300.

According to this embodiment, the tail portion 300 of the razor handle 20 includes the distal end portion 310 and the tail body 320. The tail body 320 may include the tail rod 330 and the first connection member 340.

Referring to FIG. 8, at the front end of the tail rod 330, a first protruding end accommodating portion 331 may be formed to accommodate a first protruding end 341b of a first connection member 340 therein, and a first separation preventing portion 332 may be formed to surround at least a portion of the first protruding end 341b accommodated in the first protruding end accommodating portion 331 and prevent the first protruding end 341b from being separated in the lengthwise direction. The first separation preventing portion 332 may be formed to protrude toward the inside of the first protruding end accommodating portion 331.

The first protruding end accommodating portion 331 is recessed from one surface of the tail rod 330 in a direction different from the lengthwise direction of the razor handle 20, so that the first protruding end 341b of the first connection member 340 can be inserted in or separated from the first protruding end accommodating portion 331 in the direction different from the lengthwise direction. For example, the first protruding end accommodating portion 331 is recessed from one surface of the tail rod 330 in a direction perpendicular to the lengthwise direction, so that the first protruding end 341b of the first connection member 340 can be inserted in or separated from the first protruding end accommodating portion 331 in the direction perpendicular to the lengthwise direction.

The first connection member 340 may include a tail coupling portion 341, and the first elastic coupling portion 342.

The tail coupling portion 341 may include a first extension rod 341a extending toward the rear end in the lengthwise direction of the razor handle 20, and the first protruding end 341b extending from the first extension rod 341a in a direction different from the lengthwise direction.

The first elastic coupling portion 342 may be provided at the front end of the first connection member 340. The first elastic coupling portion 342 may include at least one hook-shaped member to be detachably hooked to the first locking protrusion 119 (see FIG. 11), which will be described later. As an example of a structure where the head body 220 and the tail rod 330 are detachably coupled, FIG. 4 illustrates a detachable hook coupling structure between the clastic coupling portion 342 and the locking protrusion 221. FIG. 8 shows an example that a pair of first clastic coupling portions 342 are arranged diagonally, but the number or relative arrangement of first elastic coupling portions 342 may be varied depending on embodiments. For example, the pair of first elastic coupling portions 342 may be arranged side by side at the front end of the first connection member 340 in a horizontal or vertical direction.

This embodiment has been described based on a structure where the first connection member 340 and the tail rod 330 are separable from each other, but the first connection member 340 and the tail rod 330 may alternatively be formed as a single body. In this case, the first elastic coupling portion 342 may be formed at the front end of the tail rod 330.

Referring back to FIG. 7, the head portion 200 of the razor handle 20 according to this embodiment includes the cartridge coupling portion 210 and the head body 220. The head body 220 may include the head rod 230 and the second connection member 240.

At the rear end of the head rod 230, a second protruding end accommodating portion 231 may be formed to accommodate a second protruding end 241b of the second connection member 240 therein, and a second separation preventing portion 232 may be formed to surround at least a portion of the second protruding end 241b accommodated in the second protruding end accommodating portion 331 and prevent the second protruding end 241b from being separated in the lengthwise direction. The second separation preventing portion 232 may be formed to protrude toward the inside of the second protruding end accommodating portion 231.

The second protruding end accommodating portion 231 is recessed from one surface of the head rod 230 in a direction different from the lengthwise direction of the razor handle 20, so that the second protruding end 241b of the second connection member 240 can be inserted in or separated from the second protruding end accommodating portion 231 in the direction different from the lengthwise direction. For example, the second protruding end accommodating portion 231 is recessed from one surface of the head rod 230 in a direction perpendicular to the lengthwise direction, so that the second protruding end 241b of the second connection member 240 can be inserted in or separated from the second protruding end accommodating portion 231 in the direction perpendicular to the lengthwise direction.

Referring to FIGS. 7 and 8, the first protruding end accommodating portion 331 and the second protruding end accommodating portion 231 may be formed on opposite sides to each other. In other words, the first protruding end accommodating portion 331 may be formed on the bottom surface of the tail rod 330 as shown in FIG. 8, and the second protruding end accommodating portion 231 may be formed on the top surface of the head rod 230 as shown in FIG. 7. Alternatively, the first protruding end accommodating portion 331 may be formed on the top surface of the tail rod 330 and the second protruding end accommodating portion 231 may be formed on the bottom surface of the head rod 230, or both the protruding end accommodating portions 331 and 231 may be formed on either the top surface or the bottom surface.

Meanwhile, the first protruding end accommodating portion 331 and the second protruding end accommodating portion 231 are recessed on the tail rod 330 and the head rod 230, respectively. However, the disclosure is not limited to this example. Therefore, the first protruding end accommodating portion 331 and/or the second protruding end accommodating portion 231 may be formed penetrating the tail rod 330 and/or the head rod 230.

The second connection member 240 may include a head coupling portion 241 and a second elastic coupling portion 242.

The head coupling portion 241 may include a second extension rod 241a extending toward the front end in the lengthwise direction of the razor handle 20, and the second protruding end 241b extending from the second extension rod 241a in a direction different from the lengthwise direction.

The second elastic coupling portion 242 may be provided at the rear end of the second connection member 240. The second elastic coupling portion 242 may include at least one hook-shaped member to be detachably hooked to a second locking protrusion 118 (see FIG. 11), which will be described later. FIG. 8 shows an example that a pair of second clastic coupling portions 242 are arranged diagonally, but the number or relative arrangement of second elastic coupling portions 242 may be varied depending on embodiments. For example, the pair of second elastic coupling portions 242 may be arranged side by side at the rear end of the second connection member 340 in a horizontal or vertical direction.

This embodiment has been described based on a structure where the second connection member 240 and the head rod 230 are separable from each other, but the second connection member 240 and the head rod 230 may alternatively be formed as a single body. In this case, the second elastic coupling portion 242 may be formed at the rear end of the head rod 230.

Referring to FIG. 9, the first elastic coupling portion 342 and the second elastic coupling portion 242 may be placed inside the handle body 100 while overlapping each other. Because the first elastic coupling portion 342 and the second elastic coupling portion 242 are arranged diagonally to cross each other, physical interference is minimized while the head portion 200 and the tail portion 300 are coupled, and a space for a coupling structure between the head portion 200 and the tail portion 300 is reduced.

Referring to FIG. 11, a first locking protrusion 119 detachably coupled to the first elastic coupling portion 342 and a second locking protrusion 118 detachably coupled to the second elastic coupling portion 242 may be provided inside the handle body 100.

Each of the locking protrusions 118 and 119 and each of the elastic coupling portions 242 and 342 may be configured to be coupled by a force acting to move them closer to each other in the lengthwise direction of the razor handle 20, and may be configured to be separated by a force acting to move them away from each other in the lengthwise direction of the razor handle 20.

The coupling between each of the locking protrusions 118 and 119 and each of the elastic coupling portions 242 and 342 is similar to the coupling between the locking protrusion 221 and the elastic coupling portion 342 of the foregoing embodiment, and thus repetitive descriptions thereof will be avoided.

While the foregoing embodiments show that the head portion 200 and the tail portion 300 are detachably coupled within the razor handle 20, this embodiment shows that the head portion 200 and the tail portion 300 are detachably coupled to the handle body 100 within the razor handle 20.

Referring to FIG. 11, the first elastic coupling portion 342 and the second elastic coupling portion 242 may be configured to have a space G therebetween in the state that each of the elastic coupling portions 242 and 342 is coupled to each of the locking protrusions 118 and 119. This configuration is to secure a space where the first elastic coupling portion 342 is elastically transformable being separated from the first locking protrusion 119 and a space where the second elastic coupling portion 242 is elastically transformable being separated from the second locking protrusion 118 when the head portion 200 and the tail portion 300 are separated from the handle body 100.

The razor handle 20 according to this embodiment is also manufactured in such a way that the head portion 200 and the tail portion 300 are inserted through the opposite ends of the handle body 100 and coupled to the handle body 100 inside the handle body 100 so that the cartridge coupling portion 210 and the distal end portion 310 are fixed to the handle body 100. Therefore, the bonding for fixing the cartridge coupling portion 210 and the distal end portion 310 to the handle body 100 is not required, thereby reducing a defect rate, simplifying an assembly process, and enhancing a production speed.

Further, the razor handle 20 is separable into the handle body 100, the head portion 200 and the tail portion 300, which can be separately recycled according to their materials when the razor handle 20 is discarded.

This embodiment has been described based on an example that the head portion 200 and the tail portion 300 are coupled to the handle body 100 inside the handle body 100, but the first elastic coupling portion 342 of the tail portion 300 and the second elastic coupling portion 242 of the head portion 200 may alternatively be detachably hooked to each other.

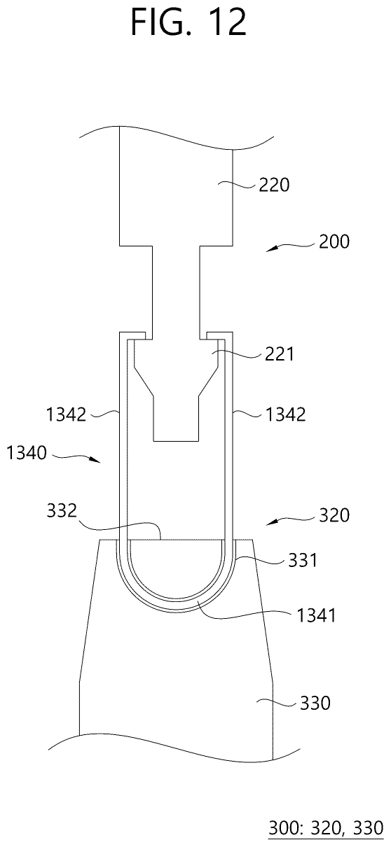

FIG. 12 is a view schematically illustrating an assembled state between a head portion 200 and a tail portion 300 in a razor handle 20 according to still another embodiment of the disclosure.

Referring to FIG. 12, the head portion 200 of the razor handle 20 according to this embodiment is similar to the head portion 200 described with reference to FIGS. 4 and 5, and thus repetitive descriptions thereof will be avoided.

However, the tail portion 300 of the razor handle 20 according to this embodiment includes a connection member 1340different from the connection member 340 described with reference to FIGS. 4 and 5.

The connection member 1340 may include a pair of elastic coupling portions 1342 extending toward the head body 220, and an elastic connecting portion 1341 connecting the pair of clastic coupling portions 1342. According to this embodiment, the connection member 1340 may be made of metal capable of elastic transformation, but is not limited thereto. Alternatively, the connection member 1340 may be made of other materials (e.g., plastic) capable of elastic transformation. However, when the connection member 1340 and the head body 220 of the head portion 200 are all made of metal, a sound is made as the clastic coupling portion 1342 of the connection member 1340 collides with the head body 220 while passing through the locking protrusion 221 in the process of coupling the head portion 200 and the tail portion 300 with each other, thereby allowing a user or worker to easily recognize the coupling between the head portion 200 and the tail portion 300.

The tail body 320 includes the tail rod 330 and the connection member 1340.

At the front end of the tail rod 330, an accommodating portion 331 may be formed to accommodate the elastic connecting portion 1341 of the connection member 1340 therein, and a separation preventing portion 332 may be formed to surround at least a portion of the elastic connecting portion 1341 accommodated in the accommodating portion 331 and prevent the elastic connecting portion 1341 from being separated in the lengthwise direction.

The accommodating portion 331 is recessed from one surface of the tail rod 330 in a direction different from the lengthwise direction of the razor handle 20, so that the clastic connecting portion 1341 of the connection member 1340 can be inserted in or separated from the accommodating portion 331 in the direction different from the lengthwise direction. For example, the accommodating portion 331 is recessed from one surface of the tail rod 330 in a direction perpendicular to the lengthwise direction, so that the clastic connecting portion 1341 of the connection member 1340 can be inserted in or separated from the accommodating portion 331 in the direction perpendicular to the lengthwise direction.

The connection member 1340 being coupled to the tail rod 330 is inserted in the handle body 100, and coupled to the head portion 200 inside the handle body 100.

In the state that the head portion 200 and the tail portion 300 are coupled inside the handle body 100, the head portion 200 and the tail portion 300 are prevented from moving in a direction away from each other as the elastic coupling portions 1342 and the locking protrusion 221 interact with each other, and the head portion 200 and the tail portion 300 are prevented from moving in a direction closer to each other as the cartridge coupling portion 210 is supported on the seating surface 111.

The razor handle 20 according to this embodiment is also manufactured in such a way that the head portion 200 and the tail portion 300 are inserted through the opposite ends of the handle body 100 and coupled to each other inside the handle body 100 so that the cartridge coupling portion 210 and the distal end portion 310 are fixed to the handle body 100. Therefore, the bonding for fixing the cartridge coupling portion 210 and the distal end portion 310 to the handle body 100 is not required, thereby reducing a defect rate, simplifying an assembly process, and enhancing a production speed.

Further, the razor handle 20 is separable into the handle body 100, the head portion 200 and the tail portion 300, which can be separately recycled according to their materials when the razor handle 20 is discarded.

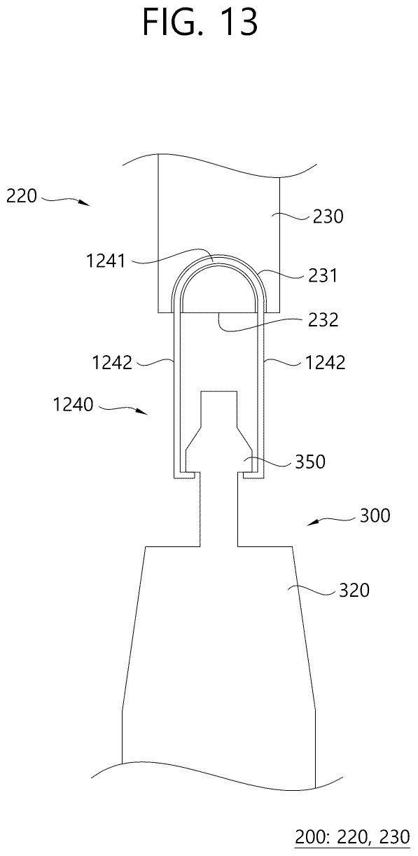

FIG. 13 is a view schematically illustrating an assembled state between a head portion 200 and a tail portion 300 in a razor handle 20 according to still another embodiment of the disclosure.

Referring to FIG. 13, the head portion 200 of the razor handle 20 according to this embodiment is similar to the tail portion 300 described with reference to FIG. 6, and thus repetitive descriptions thereof will be avoided.

However, the head portion 200 of the razor handle 20 according to this embodiment includes a connection member 1240 different from the connection member 240 described with reference to FIG. 6.

The connection member 1240 may include a pair of elastic coupling portions 1242 extending toward the tail body 320, and an elastic connecting portion 1241 connecting the pair of elastic coupling portions 1242. According to this embodiment, the connection member 1240 may be made of metal capable of elastic transformation, but is not limited thereto. Alternatively, the connection member 1240 may be made of other materials (e.g., plastic) capable of elastic transformation. However, when the connection member 1240 and the tail body 320 of the tail portion 300 are all made of metal, a sound is made as the elastic coupling portion 1242 of the connection member 1240 collides with the tail body 320 while passing through the locking protrusion 350 in the process of coupling the head portion 200 and the tail portion 300 with each other, thereby allowing a user or worker to easily recognize the coupling between the head portion 200 and the tail portion 300.

The head body 220 includes the head rod 230 and the connection member 1240.

At the rear end of the head rod 230, an accommodating portion 231 may be formed to accommodate the elastic connecting portion 1241 of the connection member 1240 therein, and a separation preventing portion 232 may be formed to surround at least a portion of the elastic connecting portion 1241 accommodated in the accommodating portion 231 and prevent the elastic connecting portion 1241 from being separated in the lengthwise direction.

The accommodating portion 231 is recessed from one surface of the head rod 230 in a direction different from the lengthwise direction of the razor handle 20, so that the elastic connecting portion 1241 of the connection member 1240 can be inserted in or separated from the accommodating portion 231 in the direction different from the lengthwise direction. For example, the accommodating portion 231 is recessed from one surface of the head rod 230 in a direction perpendicular to the lengthwise direction, so that the elastic connecting portion 1241 of the connection member 1240 can be inserted in or separated from the accommodating portion 231 in the direction perpendicular to the lengthwise direction.

The connection member 1240 being coupled to the head rod 230 is inserted in the handle body 100, and coupled to the tail portion 300 inside the handle body 100.

In the state that the head portion 200 and the tail portion 300 are coupled inside the handle body 100, the head portion 200 and the tail portion 300 are prevented from moving in a direction away from each other as the elastic coupling portions 1242 and the locking protrusion 351 interact with each other, and the head portion 200 and the tail portion 300 are prevented from moving in a direction closer to each other as the cartridge coupling portion 210 is supported on the seating surface 111.

The razor handle 20 according to this embodiment is also manufactured in such a way that the head portion 200 and the tail portion 300 are inserted through the opposite ends of the handle body 100 and coupled to each other inside the handle body 100 so that the cartridge coupling portion 210 and the distal end portion 310 are fixed to the handle body 100. Therefore, the bonding for fixing the cartridge coupling portion 210 and the distal end portion 310 to the handle body 100 is not required, thereby reducing a defect rate, simplifying an assembly process, and enhancing a production speed.

Further, the razor handle 20 is separable into the handle body 100, the head portion 200 and the tail portion 300, which can be separately recycled according to their materials when the razor handle 20 is discarded.

According to the embodiments of the disclosure, the effects are at least as follows.

The assembly process of the razor handle is simplified, thereby improving the productivity and quality of the razor handle.

When the razor handle is discarded, the handle body, the head portion, the tail portion, etc. are separately recyclable.

The effects of the disclosure are not limited to those described above, and various other effects are included in the foregoing description.

A person having ordinary knowledge in the art to which the disclosure pertains can understood that the disclosure may be embodied in other specific forms without changing technical spirit or essential features. Accordingly, the embodiments described above are illustrative and not restrictive in all aspects. The scope of the disclosure is defined by the appended claims rather than the foregoing detailed description, and all changes or modifications derived from the meaning and scope of the appended claims and their equivalents are construed as falling within the scope of the disclosure.

What is claimed is:

1. A razor handle configured to be coupled with a razor cartridge comprising at least one razor blade, the razor handle comprising:
a handle body comprising a first opening formed at a first end thereof in a lengthwise direction, and a second opening formed at a second end thereof in the lengthwise direction;
a head portion comprising a cartridge coupling portion at least partially exposed to the outside of the first opening and configured to be coupled with the razor cartridge, and a head body extending from the cartridge coupling portion and accommodated in the handle body through the first opening; and
a tail portion comprising a distal end portion at least partially exposed to the outside of the second opening, and a tail body extending from the distal end portion and accommodated in the handle body through the second opening,
wherein the head body is detachably coupled to at least one of the handle body or the tail body, and
wherein the tail body is detachably coupled to at least one of the handle body or the head body.

2. The razor handle of claim 1, wherein the head body is separated from at least one of the handle body or the tail body by a force that acts in the lengthwise direction.

3. The razor handle of claim 1, wherein the tail body is separated from at least one of the handle body or the head body by a force that acts in the lengthwise direction.

4. The razor handle of claim 1, wherein the tail body comprises a tail rod extending from the distal end portion, and a connection member connected to the tail rod and detachably coupled to at least one of the handle body or the head body.

5. The razor handle of claim 4, wherein the connection member is formed integrally with the tail rod.

6. The razor handle of claim 4, wherein:
the connection member comprises a tail coupling portion to be coupled to the tail rod, and
the tail coupling portion comprises an extension rod extending in the lengthwise direction, and a protruding end extending from the extension rod in a direction different from the lengthwise direction.

7. The razor handle of claim 6, wherein the tail rod comprises a protruding end accommodating portion to accommodate the protruding end therein, and a separation preventing portion formed to surround at least a portion of the protruding end accommodated in the protruding end accommodating portion and preventing the protruding end from being separated from the protruding end accommodating portion in the lengthwise direction.

8. The razor handle of claim 7, wherein the protruding end is inserted in or separated from the protruding end accommodating portion in a direction perpendicular to the lengthwise direction.

9. The razor handle of claim 4, wherein:
the connection member comprises an elastic coupling portion detachably coupled to at least one of the handle body or the head body, and
at least one of the handle body and the head body comprises a locking protrusion to be detachably coupled to the elastic coupling portion.

10. The razor handle of claim 4, wherein:
the connection member comprises a pair of elastic coupling portions extending toward the head body, and an elastic connecting portion connecting the pair of elastic coupling portions,
the tail rod comprises an accommodating portion to accommodate the elastic connecting portion therein, and a separation preventing portion to prevent the elastic connecting portion accommodated in the accommodating portion from being separated from the accommodating portion in the lengthwise direction, and
at least one of the handle body or the head body comprises a locking protrusion detachably coupled to the pair of elastic coupling portions.

11. The razor handle of claim 1, wherein the head body comprises a head rod extending from the cartridge coupling portion, and a connection member connected to the head rod and detachably coupled to at least one of the handle body and the tail body.

12. The razor handle of claim 11, wherein the connection member is formed integrally with the head rod.

13. The razor handle of claim 11, wherein:
the connection member comprises a head coupling portion to couple with the head rod, and
the head coupling portion comprises an extension rod extending in the lengthwise direction, and a protruding end extending from the extension rod in a direction different from the lengthwise direction.

14. The razor handle of claim 13, wherein the head rod comprises a protruding end accommodating portion to accommodate the protruding end therein, and a separation preventing portion formed to surround at least a portion of the protruding end accommodated in the protruding end accommodating portion and preventing the protruding end from being separated from the protruding end accommodating portion in the lengthwise direction.

15. The razor handle of claim 14, wherein the protruding end is inserted in or separated from the protruding end accommodating portion in a direction perpendicular to the lengthwise direction.

16. The razor handle of claim 11, wherein:
the connection member comprises an elastic coupling portion detachably coupled to at least one of the handle body or the tail body, and
at least one of the handle body or the tail body comprises a locking protrusion detachably coupled to the elastic coupling portion.

17. The razor handle of claim 11, wherein:
the connection member comprises a pair of elastic coupling portions extending toward the tail body, and an elastic connecting portion connecting the pair of elastic coupling portions,
the head rod comprises an accommodating portion to accommodate the elastic connecting portion therein, and a separation preventing portion to prevent the elastic connecting portion accommodated in the accommodating portion from being separated from the accommodating portion in the lengthwise direction, and
at least one of the handle body or the tail body comprises a locking protrusion detachably coupled to the pair of elastic coupling portions.

18. The razor handle of claim 1, wherein:
the tail body comprises a tail rod extending from the distal end portion, and a first connection member connected to the tail rod and detachably coupled to at least one of the handle body and the head body,
the head body comprises a head rod extending from the cartridge coupling portion, a second connection member connected to the head rod and detachably coupled to at least one of the handle body and the tail body,
the first connection member is separated from at least one of the handle body and the head body by a force that acts in the lengthwise direction, and
the second connection member is separated from at least one of the handle body or the tail body by a force that acts in the lengthwise direction.

19. The razor handle of claim 18, wherein:
the first connection member comprises a first elastic coupling portion detachably coupled to at least one of the handle body or the head body,
at least one of the handle body or the head body comprises a first locking protrusion detachably coupled to the first elastic coupling portion,
the second connection member comprises a second elastic coupling portion detachably coupled to at least one of the handle body or the tail body,
at least one of the handle body or the tail body comprises a second locking protrusion detachably coupled to the second elastic coupling portion.

20. The razor handle of claim 19, wherein the first elastic coupling portion and the second elastic coupling portion are detachably coupled to the first locking protrusion and the second locking protrusion, respectively, while overlapping each other inside the handle body.
